(19) United States
(12) Patent Application Publication
(10) Pub. No.: US 2023/0016539 A1
(43) Pub. Date: Jan. 19, 2023

(54) TREATMENT OF PLASTIC-DERIVED OIL

(71) Applicant: SHELL USA, INC., Houston, TX (US)

(72) Inventors: Alan Anthony DEL PAGGIO, Spring, TX (US); Wes W. Whitecotton, Houston, TX (US); Christopher Rausch, Houston, TX (US); Alexandra Ioana Sakamoto, Houston, TX (US)

(21) Appl. No.: 17/851,293

(22) Filed: Jun. 28, 2022

Related U.S. Application Data
(60) Provisional application No. 63/217,424, filed on Jul. 1, 2021.

(51) Int. Cl. C10G 1/00; B01J 20/18; B01J 20/08; B01J 20/04; B01J 20/02; B01J 20/28; B01J 20/34; C10G 1/10; C10G 69/06; C10G 61/06; B01D 15/18; B01D 15/20

(52) U.S. Cl. CPC C10G 1/002; B01J 20/18; B01J 20/08; B01J 20/04; B01J 20/0244; B01J 20/0225; B01J 20/0237; B01J 20/28061; B01J 20/28064; B01J 20/28007; B01J 20/3408; B01J 20/3433; B01J 20/3475; C10G 1/10; C10G 69/06; C10G 61/06; B01D 15/1871; B01D 15/203; C10G 2300/1003; C10G 2300/202

(57) ABSTRACT

A system for the treatment of a liquid plastic-derived oil having a pretreating section that includes a pretreating system having one or more reactors that may receive the liquid plastic-derived oil having one or more contaminants and a first contamination level. The one or more reactors includes a sorbent material having a faujasite (FAU) crystal framework type zeolitic molecular sieve and that may remove a first portion of the one or more contaminants from the liquid plastic-derived oil and generate a treated liquid plastic-derived oil having a second contamination level that is less than the first contamination level. The liquid plastic-derived oil is derived from a solid plastic waste (SPW), and the first portion of the one or more contaminants includes a halogen.

### CROSS REFERENCE TO RELATED APPLICATION

This application benefits from the priority of U.S. Provisional Patent Application No. 63/217,424, entitled “TREATMENT OF PLASTIC-DERIVED OIL,” filed Jul. 1, 2021, which is hereby incorporated by reference in its entirety.

### BACKGROUND OF THE DISCLOSURE

The present disclosure generally relates to chemical recycling of solid plastic waste. More specifically, the present disclosure relates to a pretreating system and process for removing contaminants from a plastic-derived oil.

Plastics are used in a wide variety of products ranging from packaging materials, textiles, consumer products, and electronics, among others. Within the general group of plastics, there exists a class of materials called polyolefins which are composed of polymerized monomers, such as ethylene and propylene, derived from hydrocarbons such as oil, natural gas and/or coal. These materials do not easily degrade, and a large fraction of the growing volume of plastic items produced annually may accumulate in the environment over time. Therefore, to minimize the impact of solid plastic waste (SPW) on our environment, the SPW may be recycled and reused to create post-consumer products.

There are two common techniques for SPW recycling: mechanical recycling and chemical recycling. Mechanical recycling includes separating and sorting the SPW based on shape, density, size, color and/or chemical composition, washing to remove contaminants, grinding to reduce size, compounding, and pelletizing. However, while mechanical recycling is simpler and often more inexpensive than chemical recycling, it is only applicable to a small subset of well sorted SPW. Moreover, the polymeric materials used in plastic degrade over time due to reprocessing (e.g., thermal-mechanical degradation) and lifetime degradation resulting from long-time exposure to environmental factors (e.g., heat, oxygen, light, moisture, etc.), as well as growing concentrations of impurities with each mechanical recycling cycle. Therefore, the number of times SPW may be mechanically recycled is limited to 2 to 3 cycles, after which it can no longer be mechanically recycled and is instead landfilled or incinerated.

Chemical recycling is more robust than mechanical recycling and the products obtained from chemical recycling of SPW may be used to produce new commercially viable products that are chemically indistinguishable from their virgin produced counterparts. Chemical recycling often includes separating and sorting the SPW based on chemical composition, prewashing to remove organic contaminants, grinding to reduce size, primary conversion step to produce a plastic-derived oil (thermal and/or catalytic, such as, but not limited to, pyrolysis (including catalytic pyrolysis), hydrothermal liquefaction (HTL), hydrogenolysis, etc.), often followed by a secondary conversion step (additional contamination removal and chemical conversion to ready the liquid product for utilization in a downstream unit).

End to end, the chemical recycling processes depolymerize the polymers into their respective monomers or oligomers (e.g., via chemical processes) that may then be used as petrochemical feedstock to create other products such as, for example, chemicals, fuels, and renewed plastics that have substantially identical characteristics, and thus performance, as the original materials used to make the plastic before it was recycled. Accordingly, chemical recycling represents a versatile platform to convert SPW into useful chemical products, including renewed plastics, over an indefinite number of cycles without being limited by physical or environmental degradation, and/or chemical contamination, which generally occurs in mechanical recycling. These renewed plastics and other materials produced from the repeated recycle of post-consumer plastics may be referred to as circular materials.

### SUMMARY

In an embodiment, a system for the treatment of a liquid plastic-derived oil having a pretreating section that includes a pretreating system having one or more reactors that may receive the liquid plastic-derived oil having one or more contaminants and a first contamination level. The one or more reactors includes a sorbent material having a faujasite (FAU) crystal framework type zeolitic molecular sieve and that may remove a first portion of the one or more contaminants from the liquid plastic-derived oil and generate a treated liquid plastic-derived oil having a second contamination level that is less than the first contamination level. The liquid plastic-derived oil is derived from a solid plastic waste (SPW), and the first portion of the one or more contaminants includes a halogen.

In another embodiment, a process for the treatment of a liquid plastic-derived oil includes feeding the liquid plastic-derived oil to a pretreating system including one or more reactors having a sorbent material that includes a faujasite (FAU) crystal framework type zeolitic molecular sieve. The liquid plastic-derived oil is derived from solid plastic waste (SPW), includes one or more contaminants, and has a first contamination level. The process also includes contacting, at a temperature equal to or greater than 125° C., the liquid plastic-derived oil with the sorbent material. In a preferred embodiment, the liquid plastic-derived oil is contacted with the sorbent material at a temperature equal to or greater than 150° C. The sorbent material may remove a first portion of the one or more contaminants and generate a treated liquid plastic-derived oil having a second contamination level that is less than the first contamination level, and the first portion of the one or more contaminants includes a halogen. The process further includes feeding the treated liquid plastic-derived oil to a conversion unit disposed downstream from and fluidly coupled to the pretreating system. The conversion unit includes one or more reactors that may convert the treated liquid plastic-derived oil into ethylene, propylene, butylene, and combinations thereof.

In a further embodiment, a system for the treatment of liquid plastic-derived oil includes a pretreating section having a pretreating system having one or more reactor trains that may receive a liquid plastic-derived oil having one or more contaminants and a first contamination level. The one or more reactor trains includes a plurality of reactors, each reactor in the plurality of reactors having a sorbent material having a faujasite (FAU) crystal framework type zeolitic molecular sieve and that may remove a first portion of the one or more contaminants from the liquid plastic-derived oil and generate a treated liquid plastic-derived oil having a second contamination level that is less than the first contamination level, the liquid plastic-derived oil is derived from a solid plastic waste (SPW), and the first portion of the one or more contaminants includes a halogen. The system also includes a conversion unit disposed downstream from the pretreating section. The conversion unit includes one or more reactors that may receive the treated liquid plastic-derived oil and convert the treated liquid plastic-derived oil into ethylene, propylene, butylene, and combinations thereof.

Additional features and advantages of exemplary implementations of the disclosure will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

Advantages of the disclosure may become apparent upon reading the following detailed description and upon reference to the drawings in which:

FIG. 1 is a flow diagram of a processes for chemical recycling of solid plastic waste (SPW) that includes a secondary conversion step having a pretreating system, in accordance with an embodiment of the present disclosure;

FIG. 2 is a block diagram of a system used in the secondary conversion step of FIG. 1, whereby the system includes a pretreating section having the pretreating system and a hydroprocessing section having a hydrotreater and a hydrocracker, in accordance with an embodiment of the present disclosure;

FIG. 3 is a block diagram of the pretreating system of FIG. 2, whereby the pretreating system includes multiple reactor trains, each reactor train having a plurality of reactors each having a sorbent and arranged in parallel, in accordance with an embodiment of the present disclosure;

FIG. 4 is a block diagram of the pretreating system of FIG. 2, whereby the pretreating system includes multiple reactor trains, each reactor train having a plurality of reactors each having a sorbent and arranged in series, in accordance with an embodiment of the present disclosure;

FIG. 5 is a block diagram of the pretreating system of FIG. 2, whereby the pretreating system includes multiple reactor trains, whereby one reactor train has a plurality of reactors each having a sorbent and arranged in series and another reactor train has a plurality of reactors each having a sorbent and arranged in parallel, in accordance with an embodiment of the present disclosure;

FIG. 6 is a block diagram of the pretreating system of FIG. 2, whereby the pretreating system includes a cleaning system for regenerating the sorbent in each of the plurality of reactors, in accordance with an embodiment of the present disclosure;

FIG. 7 is a plot of total chlorides in a treated liquid plastic-derived oil in parts per million (ppm) as a function of time in hours, the treated liquid plastic-derived oil is generated by contacting a heated plastic-derived oil feed with various types of sorbents, in accordance with an embodiment of the present disclosure;

FIG. 8 is a plot of total chlorides in a treated liquid plastic-derived oil in parts per million (ppm) as a function of time in hours, the treated liquid plastic-derived oil is generated by contacting a heated plastic-derived oil feed with various types of zeolitic or alumina sorbents, in accordance with embodiments of the present disclosure;

FIG. 9 is a plot of total chlorides in a treated liquid plastic-derived oil in parts per million (ppm) as a function of time in hours, the treated liquid plastic-derived oil is generated by contacting a heated plastic-derived oil feed with a zeolitic sorbent, at various temperatures, in accordance with embodiments of the present disclosure; and

FIG. 10 is a plot of total chlorides in a treated liquid plastic-derived oil in parts per million (ppm) as a function of time in hours, the treated liquid plastic-derived oil is generated by contacting a heated plastic-derived oil feed with an alumina sorbent, at various temperatures, in accordance with embodiments of the present disclosure.

### DETAILED DESCRIPTION

One or more specific embodiments of the present disclosure will be described below. These described embodiments are examples of the presently disclosed techniques. Additionally, in an effort to provide a concise description of these embodiments, not all features of an actual implementation may be described in the specification. It should be appreciated that in the development of any such actual implementation, as in any engineering or design project, numerous implementation-specific decisions will be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The terms “approximately,” “about,” and “substantially” as used herein represent an amount close to the stated amount that still performs a desired function or achieves a desired result. For example, the terms “approximately,” “about,” and “substantially” may refer to an amount that is within less than 10% of, within less than 5% of, within less than 1% of, within less than 0.1% of, and within less than 0.01% of a stated amount.

The terms “plastic-derived oil”, “liquid synthetic crude”, or “synthetic crude,” “pyrolysis oil,” liquid pyrolysis product stream,” or the like as used herein are intended to denote a liquid phase mixture derived from thermal and/or chemical conversion (e.g., pyrolysis, hydropyrolysis, hydrothermal liquefaction (HTL), hydrogenolysis, etc.) of solid plastic waste (SPW). The terms “sorbent” and “sorbent material” as used herein are intended to denote a multi-functional solid material that absorbs, adsorbs, and/or otherwise reacts with species such as, but not limited to halogens, transition metals, alkali metals, alkali earth metals, silicon (Si), phosphorus (P), sulfur (S), nitrogen (N), oxygen (O), and combinations thereof. The terms “desilication,” “desilicate,” and the like as used herein are intended to denote a process for the removal of silicon-containing species.

SPW may be converted, via pyrolysis or other thermal or chemical primary conversion step, followed by subsequent processing steps, into high-value chemicals, including olefins and hydrocarbon fuels. Primary conversion of waste plastics yields primarily liquid product streams having a wide boiling range (e.g., between approximately 20 degrees Celsius (° C.) and 750° C.), as well as gaseous, and often solid product streams. The liquid product streams, or plastic-derived oil, may include hydrocarbons across a wide boiling point range (e.g., naphtha, diesel, gasoil, and hydrowax), which may be further distilled into individual fractions, or processed directly in a steam cracker, or hydrocracker, or fluid catalytic cracker (FCC) to produce high-value chemicals, and other hydrocarbons. For example, the plastic-derived oil may be used to produce ethylene, propylene, and/or butylene, which are monomers that can be used as building blocks for new plastics. However, the plastic-derived oil also contains impurities that affect the efficiency and efficacy of plastic chemical recycling processes. For example, the plastic-derived oil contains components such as halogens, metals, and other non-carbonaceous molecules that may cause fouling and corrosion of equipment and/or render catalysts used throughout the process ineffective. In particular, the plastic-derived oil may contain chlorides derived from polyvinyl chloride (PVC) in the SPW. In certain environments, these chlorides can be corrosive to downstream equipment, through mechanisms such as but not limited to chloride stress corrosion (in the presence of water), or through formation of hydrochloric acid (HCl). Therefore, processing plastic-derived oil, which contains elevated level of chlorides, may require reactor metallurgy to be changed to more expensive alloys, or more frequent decommissioning and replacement of less expensive alloyed equipment, thereby increasing the overall cost of chemically recycling SPW. To mitigate fouling and corrosion of equipment when processing plastic-derived oil, while avoiding having to retrofit, or change downstream equipment more often, there are limits imposed on the amount of chlorides and other corrosive components that may be present in the plastic-derived oil. For example, total chlorides for feeds entering cracking equipment used in chemical recycling processes may be limited to less than 0.005 grams (g)/liter (L) (5 parts per million (ppm)) to avoid premature corrosion of downstream equipment metallurgy. Plastic-derived oils derived from SPW generally contain greater than 0.005 g/L (5 ppm) and, in certain instances, up to 8 g/L (8000 ppm) total chlorides. In addition to chlorides, the plastic-derived oils may contain other halogens (e.g., fluorine (F) and bromine (Br)) which can be converted to hydrofluoric acid (HF) or hydrobromic acid (HBr) during processing, which are highly corrosive. Other contaminants such as alkali metals (e.g., sodium (Na), potassium (K), etc.), alkaline earth metals (e.g., magnesium (Mg), calcium (Ca), etc.), a variety of transition or post-transition metals derived from, as a non-limiting example, electronics industry components or additives (e.g., selenium (Se), thallium (Tl), cadmium (Cd), mercury (Hg), lead (Pb) etc.), other non-metals such as nitrogen (N), sulfur (S), oxygen (O), or phosphorous (P), and semi-metals such as silicon (Si) and arsenic (As), may deactivate/foul catalysts used in plastic chemical recycling processes and/or result in undesirable reactions and byproducts, which decrease the efficiency and yield of the process, in addition to fouling downstream equipment. Therefore, it may be advantageous to remove, or otherwise decrease, the amount of undesirable contaminants present in the plastic-derived oil prior to processing in downstream plastic chemical recycling equipment including steam crackers.

Certain existing techniques for removal of contaminants from plastic-derived oil streams include using a solvent that extracts and removes the contaminants from the plastic-derived oil. However, solvent extraction techniques, such as those disclosed in U.S. Patent Application No. 2018/0355256, have a trade-off between the fraction of contaminants removed (e.g., chlorides) and how much of the original feedstock (e.g., the plastic-derived oil) is recovered as a final product. That is, this solvent extraction technique only removes a portion of the contaminants (e.g., chlorides). Therefore, other contaminants may still remain in the plastic-derived oil and affect downstream processes (e.g., deactivate catalysts, result in undesirable side reactions). Moreover, while solvent extraction removes the chlorides, a portion of the hydrocarbons in the plastic-derived oil is also extracted by the solvent. Consequently, the amount of plastic-derived oil that undergoes the recycling process is less and the overall yield of the recycling process is decreased. Therefore, because the solvent extraction technique does not remove a majority of the key contaminants and results in a reduced hydrocarbon yield, this technique is undesirable to meet the increasing demand for chemical recycling of SPW.

Another technique for decreasing the level of contaminants in plastic-derived oil is to blend a portion of the plastic-derived oil with naphtha or hydrowax sourced from conventional virgin crude oil refining. This mixture is co-processed in a cracker unit to generate smaller molecules used to form new chemicals. The amount of plastic-derived oil in the mixture is such that the contamination level in the mixture is within the contamination level requirements of the cracker unit. However, while this technique achieves the contamination level requirements for the cracker, this technique merely dilutes the plastic-derived oil with the naphtha/hydrowax. As such, only a small amount of the plastic-derived oil may be processed in the cracker unit at a given time. However, as the demand for plastic recycling increases, this technique is inefficient as the amount of plastic-derived oil that may be mixed with naphtha/hydrowax is limited based on the contamination level requirements of the cracker unit. Other techniques include feeding the plastic-derived oil directly into a hydrotreater without removing the contaminants. While this technique is suitable for removing certain contaminants (e.g., sulfur (S), nitrogen (N), and oxygen (O)) in the plastic-derived oil, the catalysts used in the hydrotreater are readily deactivated in the presence of other contaminants such as silicon (Si) and phosphorous (P) that are present in the plastic-derived oil. As such, the catalyst is frequently replaced, thereby decreasing the overall efficiency of this technique. Additionally, the presence of chlorides may result in premature deterioration of the hydroprocessing unit(s) metallurgy.

Other techniques include injecting an amine upstream or downstream of the hydrotreater to convert the inorganic chloride components to ammonium chloride salts, which may be removed through a water washing step downstream. Not only does this technique introduce complexity to the system, it only effectively addresses inorganic chlorides, which account for a relatively small percentage (e.g., less than approximately 10%) of the total chlorides found in plastic-derived oils. Furthermore, if injected downstream of the hydrotreater, it does not mitigate corrosion of the hydroprocessing equipment as free HCl, formed earlier in the process due to the presence of Cl in the plastic-derived oil, is still present in the equipment prior to being converted and removed by the amine. Therefore, there is an existing need to develop a more efficient technique for removing, or otherwise decreasing, various contaminants or classes of contaminants present in plastic-derived oil, ideally at the same time, such that the contamination level is at or below the contamination level requirements for equipment used in chemical recycling of plastic and to mitigate deactivation of the catalyst.

Accordingly, disclosed herein is a pretreating system that includes one or more reactors having one or more sorbents that remove contaminants such as halogens from the liquid plastic-derived oil. By using the disclosed pretreating system, the total chlorides in the synthetic crude are reduced to levels that are at or below the chloride contamination level limits of downstream hydroprocessing units or other equipment used for chemical recycling of plastic. Surprisingly, in addition to removing chlorides, the disclosed sorbents used in the pretreating system also remove other halogen contaminants (e.g., F and Br) from the liquid plastic-derived oil. While sorbents have been used to remove chlorides from hydrocarbon streams (e.g., naphtha, alkylate, raffinate, etc.), the chlorides removed are low molecular weight organic chlorides (e.g., <C₅) or inorganic chlorides in the form of hydrochloric acid (HCl) in gas phase streams. In contrast, the pretreating system and sorbents disclosed herein efficiently and effectively remove chlorides and other contaminants from complex, multicomponent hydrocarbon plastic-derived oils, with high final boiling points (FBP) (e.g., boiling range temperature between approximately 20 degrees Celsius (° C.) and 750° C.) having a concentration of total chlorides that is between approximately 5 ppm and approximately 8000 ppm. Moreover, the disclosed pretreating system decontaminants the liquid plastic-derived oil at low temperatures, and mild pressures, in an optionally hydrogen free environment. For example, the pretreating system may operate at low temperatures between approximately 125° C. and approximately 300° C., and pressures below 17 barg in the absence of hydrogen. In a preferred embodiment, the temperature of the pretreating system is approximately equal to or greater than 150° C. Unlike certain existing techniques that use temperatures in excess of 300° C., and much higher pressures (e.g., >17 barg), in the presence of hydrogen, the disclosed system and process efficiently and effectively removes the contaminants from the plastic-derived oil at temperatures less than or equal to 300° C., or less than or equal to 250° C., and pressures less than 17 barg, in the absence of hydrogen, resulting in a simpler system, with lower carbon intensity (i.e., carbon footprint). Moreover, by removing corrosive contaminants from the liquid synthetic crude upstream of conversion units used in chemical recycling of SPW, the materials used to manufacture the conversion units may not need to be upgraded, thereby decreasing the overall cost of chemically recycling SPW. The disclosed pretreating system may also be used in combination with a hydrotreater, hydrocracker or both to remove remaining trace levels of halogens, and additional contaminants (e.g., alkali metals, alkali earth metals, transition metals, and other metals and non-metals), thereby improving the robustness of chemical recycling processes for plastic waste.

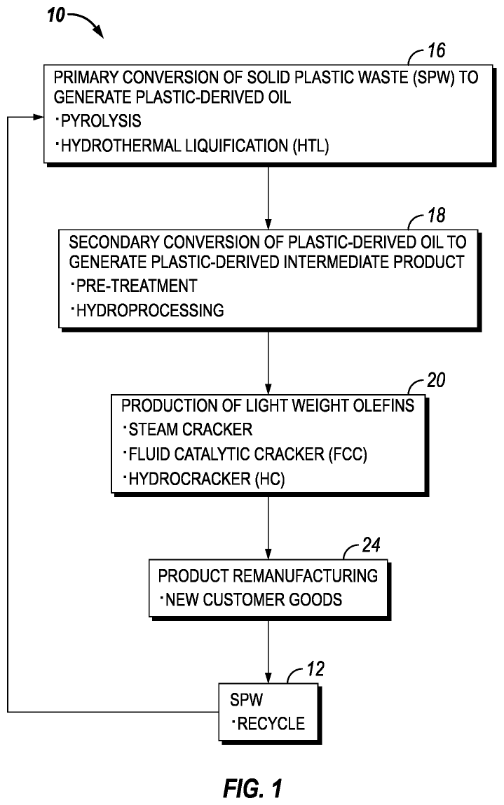

With the foregoing in mind, FIG. 1, is a block diagram of a process 10 for chemical recycling of solid plastic waste (SPW) 12 that includes a primary conversion step 16, a secondary conversion step 18, a chemical production step 20, and a product remanufacturing step 24. The SPW 12 includes post-consumer products made from various polymers such as polyethylene, polypropylene, polybutylene, polyethylene terephthalate (PET), polyvinyl chloride (PVC), nylon, teflon, polyesters, polystyrene, among others, and combinations thereof. In the illustrated embodiment, the SPW 12 undergoes processing in the primary conversion step 16 that converts solid polymers in the SPW 12 into shorter chain molecules/polymers (e.g., oligomers), thereby generating a liquid plastic-derived oil (e.g., a pyrolysis oil). For example, the primary conversion step 16 may include one or more reactors that thermally degrade the SPW 12 via pyrolysis, hydropyrolysis, hydrothermal liquefaction (HTL), or hydrogenolysis processes to depolymerize or breakdown the macrostructure of the SPW 12 and to generate the plastic-derived oil, along with light gases (e.g., methane (CH₄), ethane (CH₃CH₃), H₂S, H₂O (e.g., water vapor), etc.) and a solid residue.

The plastic-derived oil may include undesirable components such as halogens (e.g., chlorine (Cl), fluorine (F), bromine (Br)), alkali metals (e.g., lithium (Li), potassium (K), sodium (Na)), alkali earth metals (e.g., calcium (Ca) and magnesium (Mg)), transition metals (e.g., vanadium (V), zinc (Zn), iron (Fe), and nickel (Ni)), semimetals (arsenic (As) and silicon (Si), etc.), and nonmetals (e.g., nitrogen (N), sulfur (S), phosphorus (P), and oxygen (O)). These components are the result of, for example, polyvinyl chlorides (PVC), flame retardants, dyes, and additives used in certain plastics, which remain in the plastic-derived oil after the primary conversion step 16. The presence of these components in the plastic-derived oil may cause corrosion or fouling of equipment metallurgy and/or deactivation of catalysts used in downstream processes, such as the chemical production step 20. For example, the plastic-derived oil may contain at least 0.005 g/L (5 ppm) and up to 8 g/L (8000 ppm) of total chlorides. These chloride levels may result in formation of hydrochloric acid (HCl). HCl is corrosive to certain equipment, which may then require replacement. While the equipment may tolerate a certain level of chlorides, chloride levels above 0.005 g/L (5 ppm) exceed the chloride limits of the equipment, in the associated operating regime. (e.g., temperature, pressure, presence of hydrogen, etc.). As discussed above, the plastic-derived oil generated in the primary conversion step 16 may have in excess of 0.005 g/L (5 ppm). Accordingly, to mitigate fouling of equipment metallurgy, it is desirable to remove and/or decrease the level of chlorides to less than 0.005 g/L (5 ppm).

Additionally, the chemical recycling process for the SPW 12 often includes the use of various catalysts that facilitate breakdown of the long chain hydrocarbons (e.g., kerosene, diesel, hydrowax, that are >C₁₁) in the plastic-derived oil and formation of smaller molecules (e.g., naphtha range or typically C₅-C₁₁) relative to the long chain hydrocarbons. These catalysts may be sensitive to the metals, non-metals, and non-carbon molecules in the plastic-derived oil. For example, the alkali metals, alkali-earth metals, non-metals (e.g., Na, K, Si, P, etc.) and non-carbon atoms (e.g., S, N, O) may deactivate the catalyst overtime. As such, the catalyst may need to be replaced frequently, thereby decreasing the efficiency and increasing the cost of the overall process. Therefore, to mitigate deactivation of the catalysts used in these processes, it is also desirable to remove these components in the secondary conversion step 18.

The secondary conversion step 18 disclosed herein includes a pretreating system and, in certain embodiments, a hydroprocessing system that removes, or otherwise decreases, contaminants such as Cl, F, Br, K, Na, P, As, Hg, Pb, and Si and other non-carbon atoms (e.g., N, S, O) present in the plastic-derived oil to generate a treated feed having an amount of contaminants that is less than the amount of contaminants in the plastic-derived oil. The amount of contaminants in the treated feed may be between approximately 40% and 100% less than the amount of contaminants in the plastic-derived oil. By removing a substantial portion of the contaminants from the plastic-derived oil in the secondary conversion step 18, the contamination level in the resultant treated feed is suitable for processing in the chemical production step 20. As discussed in further detail below, the secondary conversion step 18 of the present disclosure uses one or more sorbents, hydroprocessing, or both to effectively and efficiently remove the contaminants in the liquid plastic-derived oil. For example, the secondary conversion step 18 may include a reactor system having one or more reactors (fixed bed, moving bed, ebullated bed, slurry reactor, etc.), each having one or more sorbent materials that primarily dehalogenate (e.g., remove halogens), but also potentially desilicate (e.g., remove silicon-containing species) and/or demetallate (e.g., remove metals), etc., the plastic-derived oil prior to hydroprocessing, if present, or FCC, or steam cracking in the chemical production step 20. In certain embodiments, the reactor may have one or more beds of sorbent material. In other embodiments, the reactor is an ebullated bed in which the sorbent material is not fixed and moves about within the reactor. The reactor system operates at a temperature less than approximately 300° C., for example, between approximately 100° C. and approximately 300° C., preferably between approximately 125° C. and approximately 250° C. The pressure within the reactor system is between approximately 0 barg and approximately 17 barg. The sorbent material may be any suitable sorbent for removal of halogens such as zeolitic molecular sieves, non-zeolitic molecular sieves, supported metals, solid supported alkali or alkali earth metals, and/or their oxides, clays, and combinations thereof. In one embodiment, the pretreating step can include the addition of a caustic component to the reactor system. In other embodiments, a nitrogen-containing component and/or a sulfur-containing component may be added upstream or downstream of the reactor system instead of or in addition to the caustic component added to the reactor system.

In embodiments in which the secondary conversion step 18 includes a hydroprocessing system, the treated plastic-derived oil is fed to the hydroprocessing system before the chemical production step 20. The hydroprocessing system removes trace residual halogens, additional components such as N, S, O, other metals, and non-metals from the treated plastic-derived oil in the presence of a hydrotreating catalyst and hydrogen to generate a hydrotreated product (HT product) or further treated feed. In certain embodiments, the hydroprocessing system may saturate olefins and aromatics present in the treated plastic-derived oil. As discussed in further detail below, the hydroprocessing system includes a hydrotreater. The hydrotreater may include one or more reactors that deoxygenate, denitrogenate and desulfurize the treated plastic-derived oil in the presence of a hydrotreating catalyst and hydrogen to generate a hydrotreated synthetic crude. The hydrotreater may also include a demetallization step which uses one or more reactors or guard beds to facilitate removal of metals and non-metals such as silicon and phosphorous, etc. Optionally, in one embodiment, the hydrotreater may also include a selective hydrogenation unit to saturate olefins. In certain embodiments, the hydrotreater may also include a sorbent for dechlorination. For example, in one embodiment, the pretreating system is omitted. Therefore, the hydrotreater includes the sorbent to remove the halogens from the plastic derived oil. In another embodiment, in addition to the sorbent material in the pretreating system, the hydrotreater may also include the sorbent material. The sorbent material in the hydrotreater may be the same or different from the sorbent material in the pretreating system. As should be appreciated, the hydrotreater includes a hydrotreating catalyst alone or in combination with the sorbent material. By way of non-limiting example, hydrotreating catalysts include alumina or other traditional grading materials, cobalt/molybdenum (CoMo) or nickel/molybdenum (NiMo) supported on alumina, and combinations thereof. However, any other suitable hydrotreating catalysts may be used.

The hydrotreating reactor may be a fixed bed, ebullated bed, fluidized bed, moving bed, bubbling bed, or any other suitable reactor and combinations thereof. The reactors in the hydrotreater may operate at a temperature of between approximately 125° C. and approximately 500° C. and a pressure of between approximately 50 barg and approximately 100 barg.

In certain embodiments, the hydroprocessing system includes a hydrocracker. The hydrocracker includes one or more reactors that further deoxygenate, denitrogenate, and desulfurize the hydrotreated plastic-derived oil and also crack the hydrocarbons to reduce the boiling point of the hydrotreated plastic-derived oil in the presence of a hydrocracking catalyst and hydrogen. By way of non-limiting example, the hydrocracking catalyst includes NiMo or nickel/tungsten (NiW) supported on alumina, Y zeolite, amorphous silicate alumina, or any other suitable hydrocracking catalyst and combinations thereof. The reactor may be a fixed bed, ebullated bed, fluidized bed, moving bed, or bubbling bed, and operates at a temperature of approximately 300° C. and approximately 500° C. and a pressure of between approximately 50 barg and approximately 150 barg. In certain embodiments, the hydrocracker operates at a temperature and pressure that is substantially equal to the temperature and pressure of the hydrotreater. In certain embodiments, the hydrocracking and hydrotreating operations may take place within the same reactor.

Following the secondary conversion step 18, the treated feed, having a contamination level suitable for downstream processing, is fed to a conversion unit that further fragments the polymeric fragments/oligomers in the treated feed to generate light olefins (e.g., ethylene, propylene, and/or butylene) in the chemical production step 20. The treated feed may be fed independently to the conversion unit or in combination with other suitable hydrocarbon feeds (e.g., co processing). The conversion unit may be a steam cracker, a fluid catalytic cracker (FCC), a hydrocracker, or any other suitable conversion unit that fragments the hydrocarbons in the treated feed (e.g., the treated plastic-derived oil) into various molecules having a reduced final boiling point (FBP). The treated feed may be preheated prior to cracking using one or more heat exchangers, furnaces, boilers, and combinations thereof. Following preheating, the treated feed may be directed to a cracking zone of a cracking unit that operates under thermal cracking conditions to generate the light olefins (e.g., ethylene, propylene, butylene) and other less desired byproducts (hydrogen, unconverted oil, naphtha, etc.). The cracking zone includes one or more furnaces, each dedicated for a specific feed or fraction of the treated feed. The cracking in the cracking zone is performed at elevated temperatures, preferably in a temperature range of between approximately 650° C. and 1000° C., and in the absence of oxygen. In certain embodiments, steam is added to the cracking zone as a diluent to reduce hydrocarbon partial pressure, thereby enhancing the light olefin yield. In addition, the steam also reduces the formation and deposition of carbonaceous material or coke in the cracking zone. A cracker effluent is obtained from cracking the treated feed, and includes aromatics, light weight olefins (e.g., ethylene, propylene, butylene), hydrogen, water, carbon dioxide (CO₂) and other hydrocarbon compounds. The cracker effluent is separated into fractions having different boiling points that may be used to make new chemicals and products in the product manufacturing step 24. Once these new consumer goods are used and discharged as the SPW 12 (e.g., post-consumer goods), the SPW 12 is once again recycled and undergoes processing in the primary conversion step 16.

Since the contamination level of the treated feed in the conversion unit (e.g., cracker) is at or below the contamination level limits for the conversion unit, fouling of the equipment metallurgy and deactivation of the catalyst(s) used in the chemical production step 20 is mitigated. Moreover, the amount of plastic-derived oil that may be processed in the chemical production step 20 may be increased compared to certain existing techniques, which dilute or extract a portion of the plastic-derived oil to reduce the contamination level. As such, the pretreating process disclosed herein, in combination with SPW recycling techniques, may meet the growing market demands for chemical recycling of the SPW 12 in a robust and efficient manner.

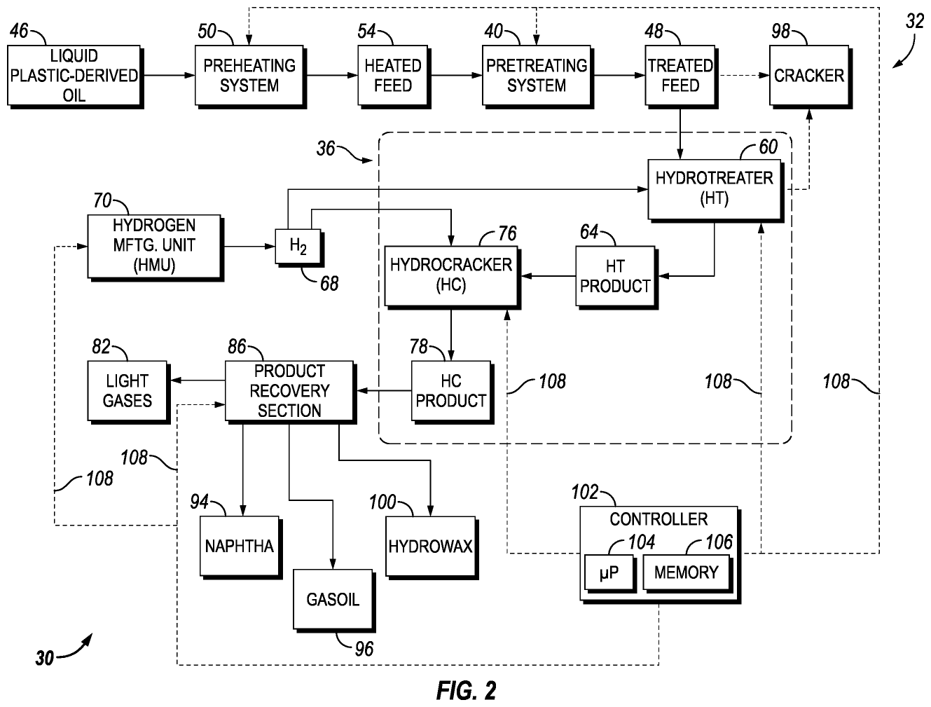

As discussed above, the plastic-derived oil generated in the primary conversion step 16 includes contaminants that may cause corrosion in downstream equipment metallurgy and deactivation of catalysts. However, pretreating the plastic-derived oil in the secondary conversion step 18 disclosed herein to remove, or otherwise decrease, the amount of contaminants in the plastic-derived oil fed to the chemical production step 20 mitigates corrosion and fouling of equipment metallurgy and deactivation of the catalysts. As such, the amount of plastic-derived oil that is processed in the conversion unit may be increased and the demands for chemically recycling SPW may be met in a robust and efficient manner. FIG. 2 is a block diagram of a system 30 that may be used in the secondary conversion step for recycling of the SPW 12, in accordance with an embodiment of the present disclosure. The system 30 may be part of a SPW management plant or a refining or chemical production plant. That is, the system 30 may be integrated into new or existing SPW management and/or chemical production plants and/or a refinery complex. In other embodiments, the system 30 may be at a stand-alone location separate from the SPW management and/or chemical production plant and/or refinery complex. The system 30 includes a pretreating section 32, a hydroprocessing section 36, and a separation section 38. The pretreating section 32 includes a pretreating system 40 that removes at least a portion of undesirable components (e.g., contaminants) present in a plastic-derived oil 46. For example, the plastic-derived oil 46 is a liquid stream generated from SPW (e.g., the SPW 12) that has undergone pyrolysis, hydropyrolysis, hydrothermal liquefaction, or hydrogenolysis in a primary conversion step (e.g., the primary conversion step 16). Accordingly, the plastic-derived oil 46 is a mixture of polymer fragments/oligomers (e.g., depolymerized polymers) and contaminants such as, but not limited to, Cl, Br, F, K, Na, Si, and P that are present in the SPW. The plastic-derived oil 46 may also include other contaminants, such as, alkali metals (e.g., Li), alkali-earth metals (e.g., Ca and Mg), transition metals (e.g., vanadium (V), zinc (Zn), iron (Fe), and nickel (Ni)), and nonmetals such as sulfur (S), nitrogen (N), and oxygen (O). As discussed above, these contaminants may cause corrosion of equipment metallurgy and/or deactivation of catalysts used in downstream processes (e.g., hydroprocessing and cracking). The pretreating system 40 includes one or more reactor systems having one or more sorbent materials that adsorb/absorb or react one or more contaminants from the plastic-derived oil 46 to generate a treated feed 48.

In the illustrated embodiment, the plastic-derived oil 46 is heated in a preheating system 50, thereby generating a heated feed 54 that is fed to the pretreating system 40. The preheating system 50 includes one or more heating devices that heat the plastic-derived oil 46 from ambient temperatures, to a temperature between approximately 125° C. and approximately 300° C. In certain embodiments, the temperature of the preheating system 50 is equal to or greater than approximately 150° C. By way of non-limiting example, the heating device includes heat exchangers, such as steam heat exchangers, boilers, and the like, and combinations thereof. While in the illustrated embodiment, the preheating system 50 is separate from the pretreating system 40, the preheating system 50 may be integrated into the pretreating system 40. In other embodiments, the system 30 may not include the preheating system 50.

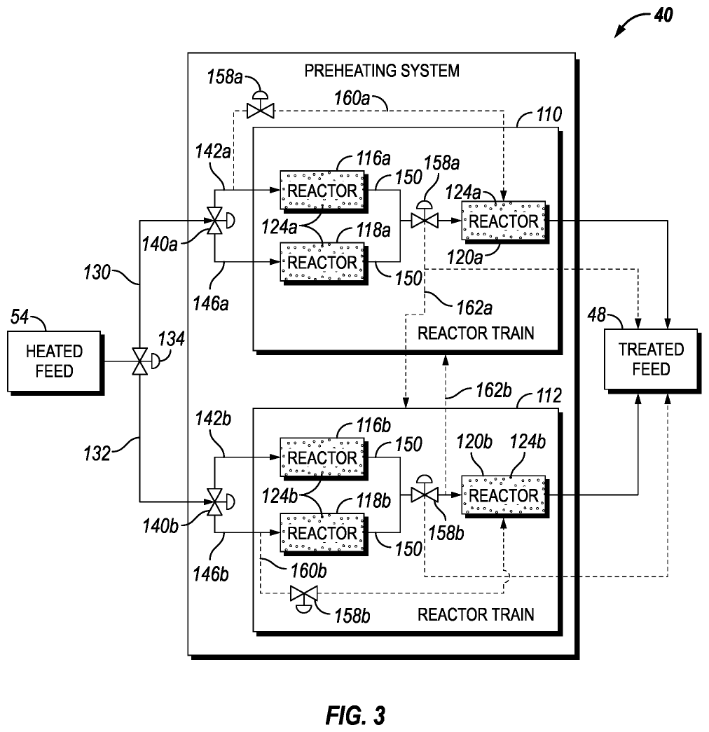

While in the pretreating system 40, the heated feed 54 flows through one or more reactors that decontaminate (e.g., dehalogenate and/or demetallate and/or desilicate, etc.) the heated feed 54 to generate the treated feed 48. While the present embodiments are discussed in the context of fixed bed reactors, it should be appreciated that the reactors may be a continuous stirred-tank reactors (CSTR), slurry tank reactors, ebullating bed reactors, moving bed reactors, fluidized bed reactors, and combinations thereof. As discussed in further detail below with reference to FIGS. 3-5, the reactors may be arranged in series, parallel, lead/lag or any other suitable arrangement that effectively and efficiently decontaminate the heated feed 54 to the desired specification. Each reactor of the one or more reactors in the pretreating system 40 includes one or more sorbent materials (e.g., adsorbent/absorbent) that selectively remove halogens (e.g., chlorine (Cl), fluorine (Fl), bromine (Br)), and potentially monovalent metals such as Na, K, divalent metals (e.g., magnesium (Mg²⁺, calcium (Ca²⁺, zinc (Zn²⁺, trivalent metals (e.g., Fe³⁺, and non-metals such as silicon (Si), phosphorous (P), nitrogen (N), sulfur (S), and oxygen (O) from a liquid phase fluid, such as the plastic-derived oil 46. The sorbent materials include, but are not limited to, zeolitic molecular sieves, non-zeolitic molecular sieves, supported metals, clays, and solid supported alkali or alkali earth metals. By way of non-limiting example, the sorbent materials include faujasite (FAU) crystal framework type zeolitic molecular sieves such as X and Y, other large pore zeolitic molecular sieves (defined as zeolites that contain 12 member ring channels (12MR)) such as, but not limited to, MOR crystal framework type zeolitic molecular sieves, medium pore zeolitic molecular sieves (defined as zeolites that contain 10 member ring channels (10MR)) such as, but not limited to, MFI crystal framework type zeolitic molecular sieves, or more specifically ZSM-5, or FER crystal framework type zeolitic molecular sieves, metal doped zeolitic molecular sieves, non-zeolitic molecular sieves, silica gels, aluminas, sodium aluminates (NaAlO₂) or ammonium (NH₄) containing materials, supported amorphous basic aluminas such as sodium oxide (Na₂O) on aluminum oxide (Al₂O₃), sodium carbonate (Na₂CO₃) on aluminum oxide (Al₂O₃), sodium carbonate (Na₂CO₃) or sodium oxide (Na₂O) plus zinc oxide (ZnO) on aluminum oxide (Al₂O₃), calcium oxide (CaO) plus zinc oxide (ZnO) on aluminum oxide (Al₂O₃), and supported metals such as nickel oxide (NiO)/Al₂O₃, copper oxide (CuO)/copper carbonate (CuCO₃)/Al₂O₃, and combinations thereof. Without being bound by theory, it is believed that the treatment performance of the sorbent material is positively impacted due, in part, to increased crystal content, reduced crystal size, and/or reduced particle size.

In certain embodiments, the heated feed 54 may have approximately 0.150 g/L (150 ppm) or more of chlorides. This level of chlorides in the heated feed 54 may result in corrosion of downstream equipment. However, to mitigate corrosion of the downstream equipment (e.g., hydroprocessing and conversion reactors, vessels, exchangers, etc.), the amount of chlorides in the heated feed 54 should be reduced to less than or equal to approximately 0.005 g/L (5 ppm) prior to entering downstream equipment. The pretreating system 40 disclosed herein dechlorinates the heated feed 54 such that the chloride level in the treated feed 48 is reduced by between approximately 40% to approximately 100% compared to the chloride levels in the plastic-derived oil 46. As such, the treated feed 48 does not cause corrosion of the downstream equipment metallurgy. For example, in one embodiment, the total chloride level in the plastic-derived oil 46 was reduced from approximately 0.170 g/L (170 ppm) to less than approximately 0.005 g/L (5 ppm). As such, the risk of corroding downstream equipment with chlorides may be reduced compared to feed streams that are not treated using the pretreating system 40 of the present disclosure. Moreover, by reducing the chloride level in the plastic-derived oil 46 prior to the chemical production step (e.g., conversion), diluting the stream by co-processing the treated feed 48 with fossil-derived naphtha or hydrowax in a conversion unit is no longer necessary. As such, the amount of the treated feed 48 that may be processed in the conversion unit to form light olefins is no longer limited, compared to untreated plastic-derived oil that has to be diluted with virgin produced naphtha or hydrowax (e.g., depending on chloride content in plastic-derived feed, and size of steam cracker, this could be in range of approximately 5 wt. %). Accordingly, the disclosed pretreating system 40 increases the overall efficiency of SPW chemical recycling compared to existing techniques.

As should be noted, the number, type, and amounts of sorbent materials used to remove the contaminants may depend on the initial contamination level, type of contaminants, and species of contaminants in the plastic-derived oil 46, desired replacement frequency of the sorbent material, target contamination level of the treated feed 48, and size and shape of the reactors in the pretreating system 40.

The one or more reactors of the pretreating system 40 may operate at a temperature range of between approximately 100° C. and approximately 300° C. and a pressure of between approximately 0 barg and approximately 17 barg. In particular, the pretreating system 40 operates at a temperature between approximately 100° C. and approximately 300° C., preferably between approximately 125° C. and approximately 250° C., and more preferably between approximately 150° C. and approximately 225° C. The reactors include inlets for receiving the heated feed 54 and other fluids such as but not limited to water, caustic, naptha, unconverted oil, toluene, etc., that maintain the reactor pressure and/or aid in dechlorination, and/or clean and/or regenerate the sorbent material, and outlets for discharging treated feed, spent fluids (e.g., sorbent cleaning or regeneration fluid), and other fluids generated in the pretreating system 40. Accordingly, the reactor may receive a flow of nitrogen gas (N₂), hydrogen gas (H₂), carbon dioxide (CO₂), natural gas or other suitable gas and combinations thereof to maintain the desired temperature and/or pressure within the reactor. As discussed in further detail below, the reactor may also receive a drying fluid (e.g., steam, air, CO₂, N₂ or other suitable fluid and combinations thereof) to clean the sorbent material or prepare it for regeneration. In one embodiment, the feed (e.g., the heated feed 54) to the pretreating system 40 and/or the treated feed 48 may be routed through a water wash system, to remove salts if present, and residual inorganic chlorides. In certain embodiments, the pretreating system 40 includes a water or caustic wash system upstream or downstream of the one or more reactors. The pretreating system 40 may also include a distillation unit upstream or downstream of the one or more beds or reactors, in certain embodiments.

Following decontamination, the treated feed 48 is fed to the hydroprocessing section 36. The hydroprocessing section 36 may include a hydrotreator 60 and hydrocracker 76. The hydrotreater 60 and the hydrocracker 76 may be in a single reactor or separate reactors. The treated feed 48 undergoes further dehalogenation and/or demetallization and/or desilication, deoxygenation, desulfurization, denitrogenation and/or olefin saturation in the hydrotreater 60. That is, in the hydrotreater 60, residual halogens, metals and non-carbon atoms such as N, S, and O are removed to generate a hydrotreated product 64 having long chain aliphatic hydrocarbons (e.g., paraffins). In addition to removing contaminants such as S, N, and O, the hydrotreater 60 also removes alkali metals (e.g., Li, Na, and K), alkali earth metals (e.g., Mg and Ca), transition metals (e.g., V, Zn, Fe, and Ni), remaining halogens (e.g., Cl, F, Br), and other non-metal contaminants such as P and Si, and partially saturated olefins. Therefore, while in the hydrotreater 60, the treated feed 48 undergoes hydroconversion in one or more hydrotreating reactors in the presence of a hydrotreating catalyst and hydrogen 68 at a pressure of between approximately 50 barg and approximately 150 barg, and at a temperature in a range of from approximately 100° C. to 500° C. In the illustrated embodiment, the hydrogen 68 is provided by a hydrogen manufacturing unit (HMU) 70. By way of non-limiting example, the HMU 70 may be a steam methane reformer or any other suitable HMU, or an electrolyzer. In certain embodiments, the hydrogen 68 may be a byproduct the SPW recycling process. For example, as shown in the illustrated embodiment, a product recovery system 86 outputs the hydrogen 68.

The hydrotreating catalyst system used in the hydrotreater 60 may be any suitable hydrotreating catalyst or combinations of hydrotreating catalysts having a desired activity in the temperature range of the disclosed hydroconversion process. For example, the hydrotreating catalyst is selected from sulfided catalysts having one or more metals from the group consisting of Ni, Co, Mo, or W supported on a metal oxide. Suitable metal combinations include sulfided NiMo, sulfided CoMo, sulfided NiW, sulfided CoW and sulfided ternary metal systems having any three metals consisting of Ni, Co, Mo, W, and noble metals. Catalysts such as sulfided Mo, sulfided Ni and sulfided W are also suitable for use. The metal oxide supports for the sulfided metal catalysts include, but are not limited to, alumina, silica, titania, ceria, zirconia, as well as binary oxides such as silica-alumina, silica-titania and ceria-zirconia, and combinations thereof. Preferred supports include alumina, silica, and titania. The support may optionally contain regenerated and revitalized fines of spent hydrotreating catalysts (e.g., fines of CoMo on oxidic supports, NiMo on oxidic supports and fines of hydrocracking catalysts containing NiW on a mixture of oxidic carriers and zeolites). Total metal loadings on the catalyst are in the range of from approximately 5 wt % to approximately 35 wt % (expressed as a weight percentage of calcined catalyst in oxidic form, e.g., weight percentage of nickel (as NiO) and molybdenum (as MoO₃) on calcined oxidized NiMo on alumina catalyst). Additional elements such as phosphorous (P) may be incorporated into the catalyst to improve the dispersion of the metal. Metals can be introduced on the support by impregnation or co-mulling or a combination of both techniques.

Following hydrotreatment, the hydrotreated product 64 is fed to a hydrocracker 76, for example, a mild hydrocracker. The hydrocracker 76 breaks down (i.e., cracks) the hydrocarbons in the hydrotreated product 64 in the presence of a hydrocracking catalyst and the hydrogen 68 to form a hydrocracked product 78 having increased portion of lighter hydrocarbons (e.g., C₅-C₉ hydrocarbons in the naphtha range) that are substantially free of oxygen, nitrogen, sulfur, metals, and halogens, and gases such as H₂, CO, and CO₂ among others. The hydrocracker 76 operates at a pressure of between approximately 50 barg to approximately 150 barg, and at a temperature in a range of from approximately 275° C. to 500° C. In certain embodiments, the temperature and pressure in the hydrocracker 76 are substantially the same as in the hydrotreater 60.

The hydrocracking catalyst used in the hydrocracker reactor 76 includes any suitable hydrocracking catalyst having a desired activity in the temperature range of the disclosed hydrocracking process. For example, the hydrocracking catalyst is selected from sulfided catalysts having one or more metals from the group consisting of Ni, Co, Mo, or W supported on a metal oxide. Suitable metal combinations include sulfided NiMo, sulfided CoMo, sulfided NiW, sulfided CoW and sulfided ternary metal systems having any three metals from the family consisting of Ni, Co, Mo, and W. Catalysts such as noble metal zeolites, sulfided Mo, sulfided Ni and sulfided W are also suitable for use. The metal oxide supports for the sulfided metal catalysts include, but are not limited to, alumina, silica, titania, ceria, zirconia, as well as binary oxides of alumina and silica being either amorphous or having defined structure such as zeolite Beta, X, or Y, silica-titania, and ceria-zirconia. Preferred supports include alumina, silica, and titania. The support may optionally contain regenerated and revitalized fines of spent hydrotreating catalysts (e.g., fines of CoMo on oxidic supports, NiMo on oxidic supports and fines of hydrocracking catalysts containing NiW on a mixture of oxidic carriers and zeolites). Total metal loadings on the catalyst are in the range of from approximately 5 wt % to approximately 35 wt % (expressed as a weight percentage of calcined catalyst in oxidic form, e.g., weight percentage of nickel (as NiO) and molybdenum (as MoO₃) on calcined oxidized NiMo on alumina catalyst). Additional elements such as phosphorous (P) may be incorporated into the catalyst to improve the dispersion of the metal. Metals can be introduced on the support by impregnation or co-mulling or a combination of both techniques.

In the illustrated embodiment, the hydrocracked product 78 is fed to the product recovery section 86. In the product recovery section 86, the liquid hydrocarbon product may undergo distillation to separate it into fractions according to ranges of the boiling points of the hydrocarbons contained in the hydrocracked product 78. For example, the hydrocracked product 78 includes naphtha range hydrocarbons 94, gasoil 96, and hydrowax 100 among others. The naphtha range hydrocarbons 94 and middle distillate range hydrocarbons 96 may be fed to a naphtha steam cracker or fluid catalytic cracker, respectively, for example, in the chemical production step 20 where it is converted into light weigh olefins used in the manufacturing of new consumer plastic goods. The remaining fractions (e.g., the hydrowax 100) may also be used in a chemical production step, (e.g., the chemical production step 20) as feed to a heavy oil steam cracker, or in other processes to generate commercially viable products such as fuels and other chemicals. In certain embodiments, the middle distillate range hydrocarbons 96 and the hydrowax 100 may be recycled to the hydrocracker reactor 76 to produce additional naphtha range hydrocarbons 94. Optionally, in certain embodiments, the naptha or heavier cuts, can be recycled to the pretreater or hydrotreater reactors. The product recovery section 86 may also generate light gases 82 (e.g., H₂, C₁ to C₄, NH₃, H₂S, H₂O (e.g., water vapor), CO, and CO₂) as byproducts.

In certain embodiments, the hydrocracked product 78 undergoes a separation process in a gas-liquid separator that separates and removes the gases (e.g., H₂, C₁ to C₄, NH₃, H₂S, H₂O (e.g., water vapor), CO, and CO₂) from the hydrocarbon liquid in the hydrocracked product 78 in either a single or multiple steps. Any suitable phase separation technique may be used to separate and remove the gases from the hydrocarbon liquid, thereby generating one or more liquid phase products. In certain embodiments, the gases are fed to a gas clean-up system that removes H₂S, NH₃ and trace amounts of organic sulfur-containing compounds, if present, as by-products of the process, thereby generating a hydrocarbon stream having CO, CO₂, H₂ and the light hydrocarbon gases. The hydrocarbon stream may be sent to the product recovery section 86. The produced hydrogen 68 may be re-used in the process. For example, the hydrogen 68 may be recycled to the hydrotreater 60 and/or the hydrocracker 76.

In certain embodiments, the hydrotreater 60, the hydrocracker 76, or both may be omitted from the system 30. For example, following treatment of the heated feed 54 in the pretreating system 40, the treated feed 48 may be fed to a conversion unit 98. For example, the conversion unit 98 may be a fluidized catalytic cracker (FCC) 98 having an integrated hydrotreater. Because the FCC includes a hydrotreater, it may be unnecessary to treat the treated feed 48 in the hydrotreater 60. In embodiments, that include the hydrotreater 60 and not the hydrocracker 78, the hydrotreated product 64 may be fed to the conversion unit 98. For example, the conversion unit 98 may be a heavy oil steam cracker or FCC that does not include a hydrotreater. As should be appreciated, once the contaminants in the plastic-derived oil 46 are removed in the pretreating system 40, the resultant treated feed 48 may be subjected to various downstream processes to generate a multitude of new plastic-derived chemicals, fuels, and consumer products without the risk of corrosion of equipment and/or catalysts used in these downstream processes.

Therefore, by using the pretreating system 40 disclosed herein to remove the contaminants in the plastic-derived oil 40 upstream of the hydroprocessing section 36 and/or chemical production processes (e.g., the chemical production step 20), the overall quality of the naphtha range hydrocarbons 94 may be improved compared to techniques that do not include the disclosed pretreating system 40. Moreover, corrosion of downstream equipment and/or deactivation of catalysts may be mitigated as contaminants such as chlorides, metals, non-metals, sulfur, and nitrogen are removed during pretreating of the plastic-derived oil 46 in the system 30. In this way, the demand for chemical recycling of SPW may be achieved in a robust and efficient manner, while also decreasing the overall cost of chemical recycling of SPW compared to existing techniques.

The system 30 may also include a controller 102 to govern operation of the system 30. The controller 102 may independently control operation of the system 30 by electrically communicating with sensors, control valves, pumps, and other flow adjusting features throughout the system 30. The controller 102 may include a distributed control system (DCS) or any computer-based workstation that is fully or partially automated. For example, the controller 102 may be any device employing a general purpose or application-specific processor 104, both of which may include memory circuitry 106 for storing instructions such as system parameters (e.g., pretreating conditions, hydrotreatment conditions, hydrocracker conditions, sorbent regeneration conditions, etc.). The processor 104 may include one or more processing devices, and the memory circuitry 106 may include one or more tangible, non-transitory, machine-readable media collectively storing instructions executable by the processor 104 to control actions described herein.

In one embodiment, the controller 102 may operate control devices (e.g., valves, pumps, etc.) to control amounts and/or flows between the different system components. It should be noted that there may be valves throughout the system 30 used to adjust different amounts and/or flows between system components. For example, the controller 102 may also govern operation of valves to control an amount or adjust a flow of the plastic-derived oil 46, the heated feed 54, the treated feed 48, the hydrotreated product 64, the hydrocracked product 78, and hydrogen 68 that are fed to the different components of the system 30. In certain embodiments, the controller 102 may use information provided via input signals to execute instructions or code contained on a machine-readable or computer-readable storage medium (e.g., the memory circuitry 106) and generate one or more output signals 108 to the various control devices (e.g., valves, pumps, etc.) to control a flow of fluids (e.g., the plastic-derived oil 46, the feeds 48, 50, the products 64, 78, hydrogen 68 or other suitable fluids) throughout the system 30.

As discussed above, the pretreating system 40 includes one or more reactors that receive and treat the heated feed 54 to remove contaminants such as halogens that may be present in the plastic-derived oil 46. FIGS. 3-5 illustrate various arrangements of the reactors in the pretreating system 40. For example, in the embodiment illustrated in FIG. 3, the pretreating system 40 includes a first reactor train 110 and a second reactor train 112. To facilitate discussion of the embodiments illustrated in FIGS. 3-5, only two reactor trains 110, 112 are shown. However, the pretreating system 40 may have any number of reactor trains. For example, the pretreating system 40 may have 1, 2, 3, 4, 5, 6, 7, 8, 9, 10 or more reactor trains 110, 112. Each reactor train 110, 112 includes one or more reactors 116, 118, 120 having a sorbent material 124 that removes the contaminants from the heated feed 54. While the illustrated embodiment only depicts three reactors 116, 118, 120, the reactor train 110, 112 may have any suitable number of reactors, such as 1, 2, 3, 4, 5, 6, 7, 8, 9, 10, or more reactors. The number of reactors 116, 118, 120 in each of the reactor trains 110, 112 may be the same or different. For example, the first reactor train 110 may have the three reactors 116, 118, 120, and the second reactor train 112 may have one or two of the reactors 116, 118, 120 and vice versa. In the illustrated embodiment, the reactor trains 110, 112 each have the same number of reactors 116, 118, 120. The reactors 116, 118, 120 may be fluidized bed reactors, ebullated bed reactors, fixed bed reactors, bubbling bed reactors, moving bed reactors, or any other suitable reactor and combinations thereof. For example, in one embodiment, the reactor 116 may be a fluidized bed reactor and the reactor 118, 120 may be a fixed bed reactor or other reactor different from the reactor 116.

The sorbent material 124 in the reactor 116, 118, 120 may be any sorbent material suitable for removing halogens (e.g., chlorides, bromine, fluoride), metals (e.g., monovalent, divalent, trivalent metals), and non-metals (e.g., Si, P, N, etc.). By way of non-limiting example, the sorbent material 124 may be faujasite (FAU) crystal framework type zeolitic molecular sieves such as X and Y, other large pore zeolitic molecular sieves (defined as zeolites that contain 12 member ring channels (12MR)) such as but not limited to MOR crystal framework type zeolitic molecular sieves, medium pore zeolitic molecular sieves (defined as zeolites that contain 10 member ring channels (10MR)) such as but not limited to MFI crystal framework type zeolitic molecular sieves, or more specifically ZSM-5, or FER crystal framework type zeolitic molecular sieves, doped zeolitic molecular sieves, non-zeolitic molecular sieves, silica gels, clays, aluminas, sodium aluminate or ammonium (NH⁴⁺) containing materials, supported amorphous basic aluminas such as sodium oxide (Na₂O) on aluminum oxide (Al₂O₃), sodium carbonate (Na₂CO₃) on aluminum oxide (Al₂O₃), sodium carbonate (Na₂CO₃) or sodium oxide (Na₂O) plus zinc oxide (ZnO) on aluminum oxide (Al₂O₃), calcium oxide (CaO) plus zinc oxide (ZnO) on aluminum oxide (Al₂O₃), and supported metals such as nickel oxide (NiO)/Al₂O₃, copper oxide (CuO)/copper carbonate (CuCO₃)/Al₂O₃, metal-organic frameworks (MOF), and combinations thereof. In one embodiment, the sorbent material 124 may have an elemental alkali metal (e.g., Li, Na, K, etc.), alkali earth metal, or transition metal content of approximately 1 wt % to approximately 50 wt %. The sorbent material 124 may have a Si/Al ratio less than 10, preferably, a Si/Al ratio less than 5. The mole sieve average crystallite size of the sorbent material 124 may be between approximately 5 nanometers (nm) and 100 microns (μm), as determined by laser particle sizing. For example, the average crystallite size of the sorbent material 124 may be between approximately 5 nm and 100 μm, between approximately 50 nm and 50 μm, or between approximately 100 nm and 25 μm. In certain embodiments, the sorbent material 124 may have a t-plot method determined surface area of approximately 100 m²/g to approximately 800 m²/g, preferably, a t-plot method determined surface area of approximately 200 m²/g to approximately 800 m²/g, or most preferably a t-plot method determined surface area of approximately 300 m²/g to approximately 800 m²/g.

In one embodiment, the sorbent material 124 is the same in each reactor 116, 118, 120 in all the reactor trains 110, 112. In certain embodiments, the reactors 116a, 118a, 120a in the first reactor train 110 have one sorbent material 124, and the reactors 116b, 118b, 120b in the second reactor train 112 have a sorbent material 124 that is different from that in the reactors 116a, 118a, 120a. In other embodiments, the sorbent material 124 in each of the reactors 116, 118, 120 in the reactor train 110, 112 is different. That is, the sorbent material 124 in the reactor 116a, 116b may be different from the sorbent material 124 in the reactor 118a, 118b, 120a, 120b.

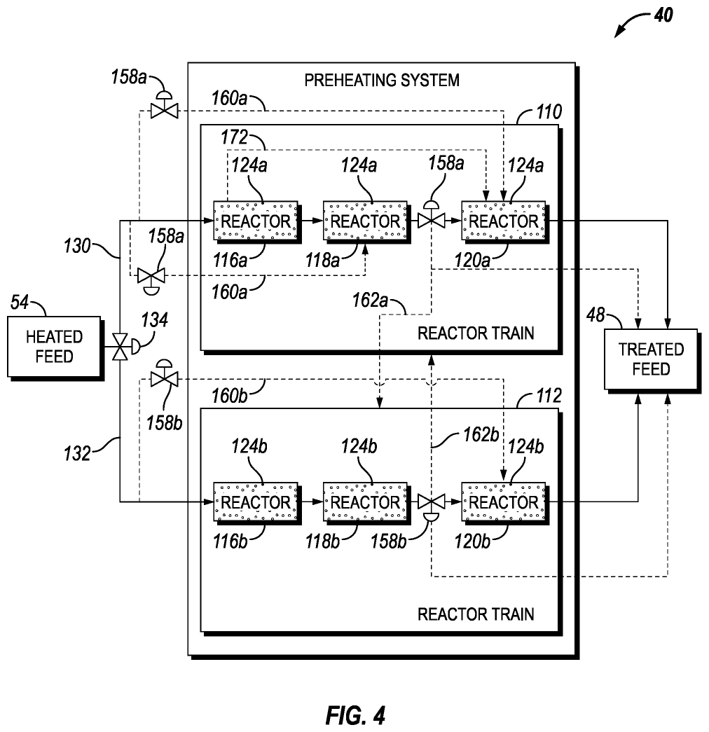

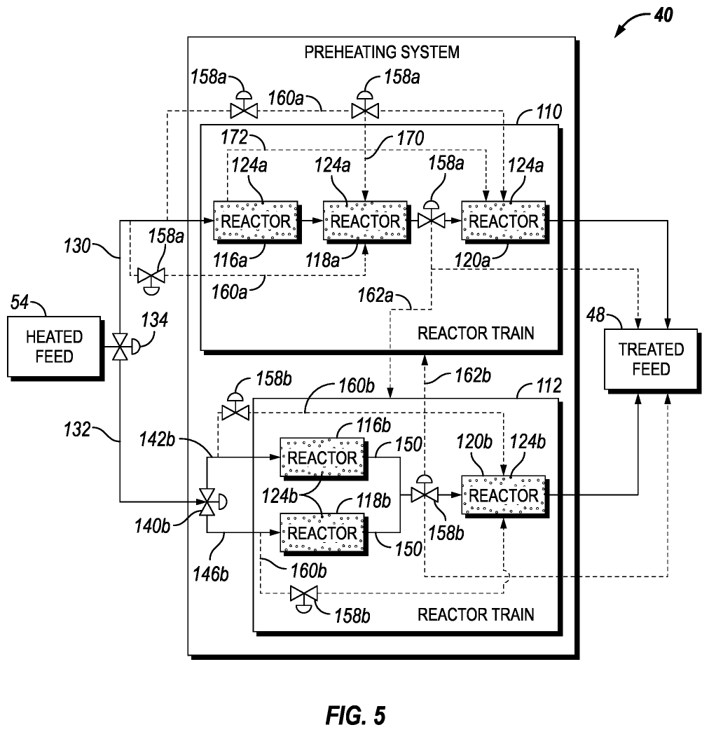

The reactors 116, 118, 120 in the reactor trains 110, 112 may be arranged in any suitable manner that effectively and efficiently removes the contaminants from plastic-derived oil (e.g., the plastic-derived oil 46). For example, the reactors 116, 118, 120 may be arranged in parallel, series, lead/lag, etc. The reactor arrangement may be the same or different in each reactor train 110, 112 of the pretreating system 40. For example, in FIG. 3, the reactor trains 110, 112 each have the reactors 116, 118 arranged in parallel, and the reactor 120 arranged in series with respect to the reactors 116, 112. However, in certain embodiments, the reactors 116, 118, 120 may be arranged in series as shown in FIG. 4. In other embodiments, the reactors 116, 118, 120 may have a different arrangement in each of the reactor trains 110, 112. For example, as shown in FIG. 5, the reactors 116a, 118a, 120a in the reactor train 110 are arranged in series and the reactors 116b, 118b, 120b in the reactor train 112 are arranged in a combination of parallel and series.

The pretreating system 40 includes various conduits, flow control devices (e.g., valves, flow sensors) that direct the heated feed 54 and other fluids throughout the pretreating system 40 to generate the treated feed 48. For example, during operation, the pretreating system 40 receives the heated feed 54 via conduits 130, 132 that feed it to the reactor trains 110, 112, respectively. In the illustrated embodiment, the flow of the heated feed 54 is split between the conduits 130, 132 by a control valve 134 (e.g., a three-way valve). However, in other embodiments, the control valve 134 may block the flow of the heated feed 54 to the first reactor train 110, the second reactor train 112, or both. For example, during operation of the pretreating system 40, flow to the reactor train 110, 112 may be blocked due to maintenance of the reactor train 110, 112 or sorbent decontamination, or regeneration of the sorbent material 124 in one of the reactors 116, 118, 120. As such, the pretreating system 40 may continue to treat the heated feed 54 in the reactor train 110, 112 that is not undergoing maintenance without shutting down the complete system 40. Moreover, in certain embodiments, the amount of heated feed 54 undergoing the pretreating process is such that multiple reactor trains 110, 112 are not necessary. As such, the control valve 134 may block the flow of the heated feed 54 to reactor trains 110, 112 that are not required for pretreating the heated feed 54.

Once the heated feed 54 is fed to the reactor train 110, 112, the heated feed 54 flows into one or more of the reactors 116, 118, 120. For example, as illustrated in FIG. 3, the reactors 116, 118 are arranged in parallel. Accordingly, the heated feed 54 may flow into the reactors 116, 118 simultaneously. However, in other embodiments the reactor 116, 118, 120 are arranged in series, as shown in FIG. 4. Therefore, in this embodiment, the heated feed 54 flows into one reactor (e.g., the reactor 116) and the output of that reactor flows into the following reactor (e.g., the reactor 118).

The pretreating system 40 may have additional valves that may control the flow of the heated feed 54 between the reactors 116, 118, 120 and/or the reactor trains 110, 112. For example, in the embodiment illustrated in FIG. 3, a valve 140 may be used to control the flow of the heated feed 54 to the reactors 116, 118 via conduits 142, 146. While in the reactors 116, 118, the heated feed 54 contacts the sorbent material 124 and a portion of the contaminants are removed from the heated feed 54. For example, as discussed above, the sorbent material 124 dechlorinates and removes other halogens (e.g., bromine and fluorine) from the heated feed 54 to generate an intermediate feed 150 having a halogen contamination level that is less than the halogen contamination level of the heated feed 54. The intermediate feed 150 is directed to the reactor 120 in which the feed 150 contacts the sorbent material 124 to remove any remaining halogen contaminants and generate the treated feed 48.

The reactor train 110, 112 may have one or more bypass valves 158 that may be used to bypass the reactor 116, 118, 120 during operation of the system 40. For example, during maintenance and/or regeneration of the reactor 116, the bypass valve 158 blocks the flow of the heated feed 54 in the conduit 142 and directs it to the reactor 120 via bypass line 160. Similarly, the intermediate feed 150 may bypass the reactor 120 (e.g., during maintenance, regeneration of the sorbent, and/or if the reactor 120 is not necessary for treatment of the feed). In certain embodiments, the intermediate feed 150 may be fed to any one of the reactors 116, 118, 120 in the reactor train 110, 112 via bypass line 162.

In embodiments, in which the reactors 116, 118, 120 are arranged in series, as illustrated in FIG. 4, the reactor train 110, 112 may include additional bypass lines 170, 172. The bypass line 172 may be used to bypass the reactor 118 and feed the output of the reactor 116 to the reactor 120, for example, when the reactor 118 is undergoing maintenance, repair, and/or sorbent regeneration. Similarly, the bypass line 170, illustrated in FIG. 5, may be used when the reactor 116 is undergoing maintenance, repair, and/or sorbent regeneration, to direct the heated feed 54 to the reactor 118. In this way, the pretreating system 40 may continue to treat the heated feed 54 in the respective reactor train 110, 112 and reactors 116, 118, 120 without having to shut down the system 40 and/or the reactor train 110, 112. As should be appreciated, the pretreating system 40 may have flow control valves, conduits, sensors, inlets, outlets, and other structural components not shown that facilitate treatment of the heated feed 54 and operation of the system 40 and do not depart from the scope of the present disclosure. In one embodiment, the heated feed 54 and/or pretreating reactor product (e.g., the treated product 48 or intermediate product 150) may be routed through a water wash system, to remove salts if present, and residual inorganic chlorides.

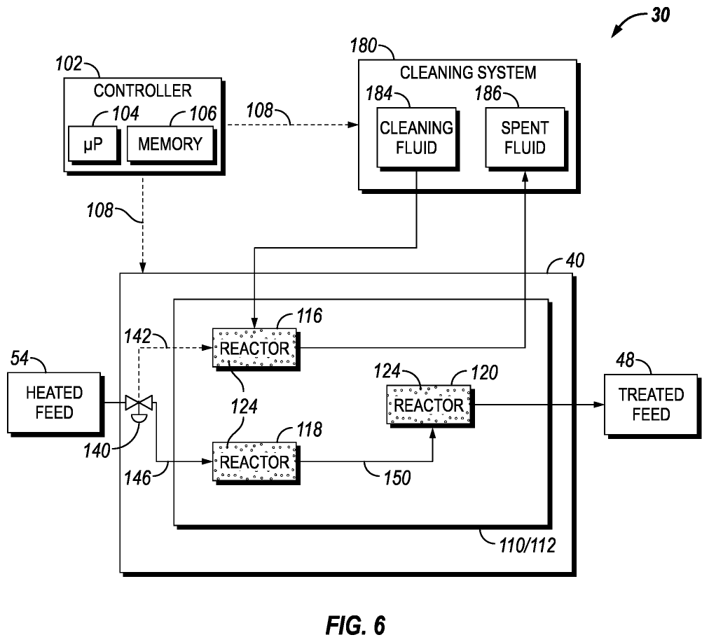

As discussed above, the pretreating system 40 removes at least a portion of the contaminants present in the heated feed 54 using the sorbent material 124. Over time, the sorbent material 124 may become saturated with the contaminants and other components (e.g., hydrocarbons and/or salts, etc.) and may be unable to effectively remove the contaminants from the heated feed 54. Therefore, the sorbent material 124 may be regenerated to strip, or otherwise remove, the adsorbed/absorbed contaminants from the sorbent material 124 such that it may be reused. For example, as illustrated in FIG. 6, the system 30 includes a cleaning system 180 that may be used to clean and optionally regenerate the sorbent material 124. The cleaning system 180 provides a cleaning fluid 184 (e.g., a liquid or gas) to the reactor 116, 118, 120 that has the sorbent material 124 saturated with hydrocarbons and/or contaminants. By way of non-limiting example, the cleaning fluid 184 may be a hydrocarbon, hydrogen, nitrogen, water, caustic, salt wash, or any other suitable fluid and combinations thereof that rids the sorbent material 124 of occluded hydrocarbons, removes the contaminants from the sorbent material 124, or both. By removing the contaminants from the sorbent material 124, the sorbent material 124 may be regenerated and reused for additional contaminant removal cycles. These steps may be performed in series or in parallel. In one embodiment, a first cleaning fluid (e.g., naphtha) 184 is fed to the reactor 116 to decontaminate the sorbent material 124 from heavier hydrocarbons (e.g., >C7) and, optionally, is followed by one or more additional cleaning fluids (e.g., H₂, nitrogen, etc.) to remove lighter hydrocarbons (e.g., <C₇). Additional cleaning fluids (e.g., water, caustic, etc.) may be fed to the reactor 116 to remove polar materials and/or to regenerate the functionality of the sorbent material 124. However, the order by which the components on the sorbent material 124 are removed may be different (e.g., hydrocarbon, salt, etc.).

During a cleaning and/or regeneration cycle, the valve 140 blocks a flow of the heated feed 54 to the reactor 116, thereby isolating the reactor 116 from the pretreating operation. Once the reactor 116 is isolated, the cleaning fluid 184 is fed to the reactor 116 to remove the adsorbed/absorbed contaminants from the sorbent material 124 and generate a spent fluid 186 having the contaminants. This process may be repeated multiple times. The spent fluid 186 may be directed to a holding tank in the cleaning system 180 or may be discarded. In one embodiment, the cleaning system 180 may remove the contaminants from the spent fluid 186 to generate at least a portion of the cleaning fluid 184. In certain embodiments, the spent fluid 186 may contain chloride components and may be directed to a system that converts the chloride components to hydrochloric acid (HCl) or is otherwise removed. While the regeneration of the sorbent 124 is described in the context of the reactor 116, it should be appreciated that the sorbent material 124 in the reactors 118, 120 is regenerated in a similar manner.

During the sorbent regeneration cycle, the controller 102 may provide instructions to close valves and block the flow of the feed 54, 150 into the reactors 116, 118, 120. Additionally, the controller 102 may also provide instructions to selectively open valves based on a stage of the sorbent regeneration cycle to selectively enable flow of the cleaning fluid 184 to the respective reactor 116, 118, 120 and the spent fluid 186 to the cleaning system 180 or other spent fluid processing system. The controller 102 may monitor the contamination level of the reactor output (e.g., the intermediate feed 150 and/or the treated feed 48) during operation of the system 40. If the contamination level in the reactor output is above a predetermined threshold, the controller 102 generates the output signal 106 instructing the system 40 to commence the sorbent regeneration process. The controller 102 may monitor the level of contaminants in the spent fluid 186 during the sorbent regeneration cycle. Once the level of contaminants in the spent fluid 186 is below a desired threshold or at or near zero, the controller 102 outputs another signal 106 instructing the system 40 to stop the sorbent regeneration cycle and re-start pretreating of the feed 54, 150 in the respective reactor 116, 118, 120.

### EXAMPLES

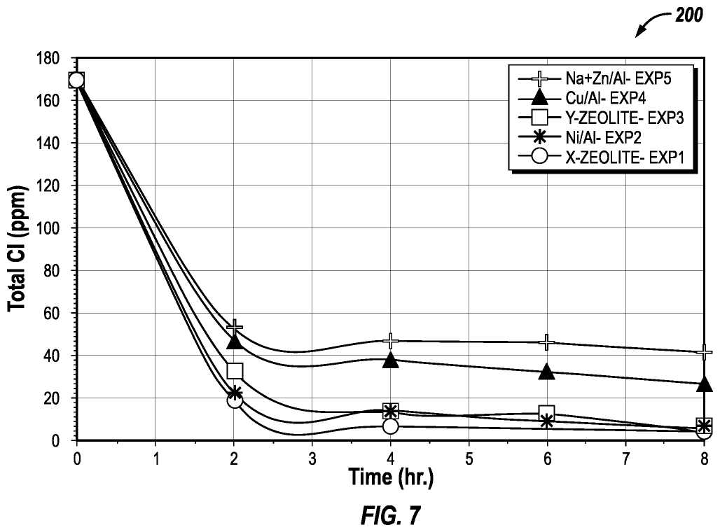

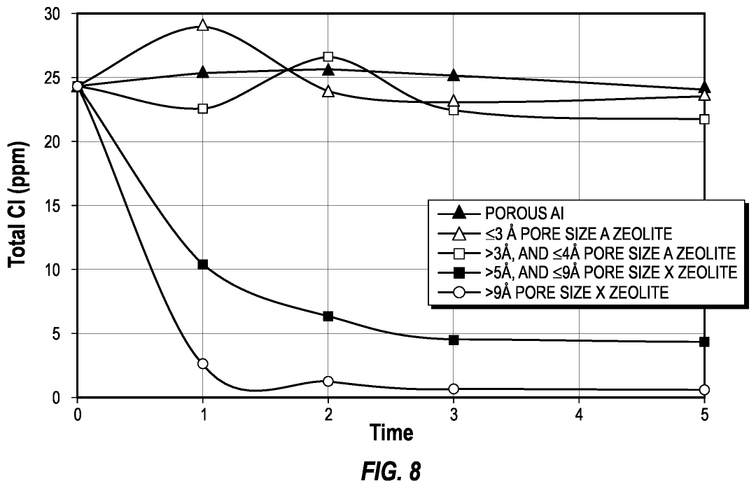

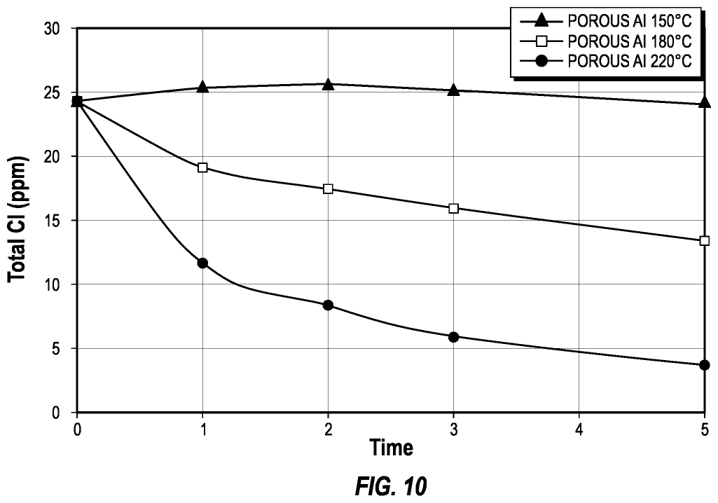

Set forth below are experiments illustrating the chloride removal efficacy of commercially available sorbent materials that may be used in the pretreating system disclosed herein. The chloride removal efficacy of the sorbent materials was tested using commercially available plastic-derived oils originating from solid plastic waste (SPW) having a total chloride concentration of at least 24 parts per million (ppm). Each experiment was performed in a 300 milliliter (mL) (for experiments in FIG. 7-9) or 600 milliliter (mL) (for experiments in FIG. 10) batch autoclave by first adding the plastic-derived oil to a sorbent, in a given ratio, then raising the temperature to approximately 150° C. in the presence of nitrogen gas (N₂), while agitating the contents. Samples were taken throughout the experiment and analyzed. The sorbent to oil ratio (S:O) for each experiment was 20:80 by mass (for experiments shown in FIG. 7) or 5:95 by mass (for experiments shown in FIGS. 8-10). That is, the mass of the sorbent material in the reactor vessel was 20% and the mass of the plastic-derived oil was 80%. The amount of chloride (Cl) in the plastic-derived oil after having passed through the sorbent material, hereinafter “the treated plastic-derived oil”, was determined as a function of time using X-ray fluorescence (XRF) according to ASTM D7536. Other contaminants (e.g., N, S, F, Br, K, Na, and Si) were measured in the treated plastic-derived oil, after the autoclave contents were cooled down to ambient temperatures, and separated from the sorbent, according to ASTM D5762 for N & S, using inductively coupled plasma (ICP) (e.g., direct infusion (DI)-ICP for Si, and ICP-optical emission spectroscopy (OES) for remaining non specified contaminants), XRF for Cl and P, combustion ion chromatography (CIC) for F, Br, Flame Atomic Absorption (FAA) for Na, K, etc. However, any other suitable analytical technique may be used to measure the amount of contaminants present in the treated plastic-derived oil.

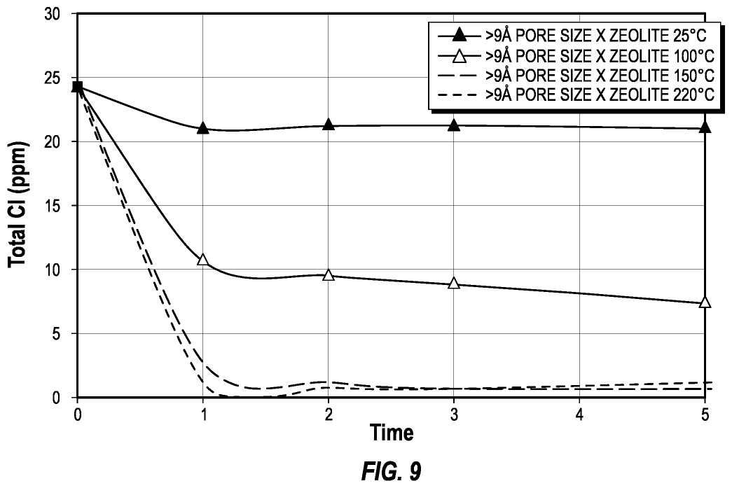

As shown in Table 1, the amount of the N, S, F, Cl and Si contaminants in the plastic-derived oil were reduced by between approximately 40% and approximately 99% at a temperature of 150° C., depending on the sorbent material. As discussed above, certain existing techniques for removal of chlorides require gas phase operation where the chloride is converted to HCl and then removed through subsequent downstream steps. These existing techniques usually occur at temperatures in excess of 300° C. and in the presence of hydrogen. However, as shown in Table 1, the pretreating system disclosed herein removes chlorides in the liquid phase and at temperatures below 300° C. FIG. 7 is a plot 200 of total chloride in the plastic-derived oil, in ppm, as a function of time in hours for various sorbent materials. While all sorbent materials tested reduced the total chlorides in the plastic-derived oil by between approximately 45% and 99%, the sorbent materials having the highest efficacy for chloride removal were the basic X zeolitic molecular sieve, the basic Y zeolitic molecular sieve, and the metal supported alumina material Ni/Al. Surprisingly, the sorbent materials were also able to effectively reduce the amount of N by between approximately 76% and approximately 99%, S by between approximately 78% and approximately 92%, F by approximately 86%, and Si by between approximately 67% and approximately 93% compared to the N, S, F, and Si present in the plastic-derived oil prior to pretreating. Chloride removal of less than 15% relative to the amount of chloride in the plastic-derived oil prior to pretreating was observed for experiments with mesoporous alumina (Al), very small pore A zeolites (i.e., pore size equal to or less than approximately 3 Angstroms (Å), such as, for example, 3 A), or small pore A zeolite (i.e., pore size greater than approximately 3 Å to equal to or less than approximately 4 Å such as, for example 4A) at an S:O ratio of 5:95, at 150° C., or with X-zeolites at room temperature. The X zeolites include large pore X zeolites (i.e., pore size greater than approximately 5 Å to equal to or less than approximately 9 Å such as, for example 9A, or very large pore X zeolites (i.e., pore size greater than approximately 9 Å such as, for example 13×), as shown in FIG. 8, with a second type of plastic-derived oil. Therefore, as shown in FIG. 8, different types of zeolitic molecular sieves have different chloride removal efficacies based on framework type. For example, X and Y zeolites having an FAU-type framework have a better chloride removal efficacy compared to A zeolites, with an LTA-type framework. Additionally, as shown in FIG. 9, the chloride removal efficacy of the X-zeolite is dependent on the temperature. For example, at temperatures below 100° C., the chloride removal efficacy is undesirable. However, at temperatures equal to or greater than 150° C., the chloride removal efficacy of the X-zeolite is at desirable levels (e.g., more than 90% of chloride is removed, resulting in a treated feed chloride concentration less than 5 ppm) Moreover, as shown in FIG. 10, the chloride removal efficacy of porous alumina sorbents is less than that of the X-zeolite across all temperatures. Indeed, at a temperature of 180° C., the chloride levels in the treated feed were above 10 ppm when porous alumina was used as the sorbent material. Additionally, while the chloride levels at 220° C. were reduced to less than 5 ppm with porous alumina, the amount of time to achieve these levels was 3 times longer compared to the X-zeolite at the same temperature (see, e.g., FIG. 9).

TABLE 1
CONTAMINANT REMOVAL USING VARIOUS SORBENTS

| | | Plastic | | | | | | |
|---|---|---|---|---|---|---|---|---|
| | | Derived | | | | | | |
| | | Oil | Treated Plastic Derived Oil | | | | | |
| | | — | EXP 1 | EXP 2 | EXP 3 | EXP 4 | EXP 5 | EXP 6 |
| | Sorbent | — | (Na + Zn)/Al | Ni/Al | Y-Zeolite | Cu/Al | X-Zeolite | X-Zeolite 2 |
| Contaminant | N | 345 | 81 | 44 | 4 | 36 | 2 | 181 |
| Levels | S | 72 | 10 | 8 | 16 | 6 | 7 | 20 |
| (ppm) | F | 7 | 8 | 1 | 1 | 2 | 8 | — |
| | Cl | 170 | 25 | 7 | 3 | 30 | 1 | 87 |
| | Si | 15 | 5 | 2 | 1 | 5 | 2 | 9 |

The technical effects of pretreating a liquid plastic-derived oil derived from solid plastic waste (SPW) using the pretreating system disclosed herein improves chemical recycling of SPW and mitigates premature corrosion and fouling of downstream equipment and deactivation of catalysts used throughout the chemical recycling process for SPW. For example, existing techniques for chemical recycling of SPW dilute the liquid plastic-derived oil with fossil-derived naphtha such that the contamination level of the plastic-derived oil does not exceed the limits tolerated by equipment (e.g. steam crackers) that would otherwise lead to corrosion and fouling (e.g., corrosion caused by chlorides in the plastic-derived oil). However, by using the pretreating system disclosed herein, the chlorides and other contaminants that may cause corrosion, fouling of equipment and/or deactivation of the catalysts are removed from the liquid plastic-derived oil prior to conversion steps such as hydrocracking or steam cracking. By removing the contaminants, the contamination level of the liquid plastic-derived oil is decreased to levels below the contamination level limits tolerated by the equipment compared to techniques that do not include the pretreating system disclosed herein, as discussed above with reference to FIG. 2. As such, the materials of construction used in the manufacture of conversion units used in chemically recycling SPW may not need to be upgraded as the risk of corrosion is decreased by removing corrosive contaminants upstream of these conversion units. Moreover, the disclosed pretreating system may be used to treat liquids with a high final boiling point (FBP) having a concentration of chlorides, in a non-hydrogen environment. Additionally, the disclosed sorbent materials used in combination with the pretreating system effectively remove contaminants other than chlorides from the liquid plastic-derived oil, thereby mitigating fouling of catalysts used in chemical recycling processes for SPW. Accordingly, the disclosed system provides an effective, efficient, and robust technique for chemical recycling of SPW.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

We claim:

1. A system for the treatment of a liquid plastic-derived oil comprising:
a pretreating section comprising a pretreating system having one or more reactors configured to receive the liquid plastic-derived oil having one or more contaminants and a first contamination level, wherein the one or more reactors comprises a sorbent material comprising a faujasite (FAU) crystal framework type zeolitic molecular sieve and configured to remove a first portion of the one or more contaminants from the liquid plastic-derived oil and to generate a treated liquid plastic-derived oil having a second contamination level that is less than the first contamination level, wherein the liquid plastic-derived oil is derived from a solid plastic waste (SPW), and wherein the first portion of the one or more contaminants comprises a halogen.

2. The system of claim 1, comprising a hydroprocessing section disposed downstream from and fluidly coupled to the pretreating section, wherein the hydroprocessing section comprises a hydrotreater comprising one or more hydrotreating catalysts, wherein the hydrotreater is configured to receive the treated liquid plastic-derived oil and hydrogen gas, to remove a second portion of the one or more contaminants from the treated liquid plastic-derived oil, and to generate a hydrotreated liquid product having a third contamination level that is less than the second contamination level.

3. The system of claim 2, wherein the hydrotreater comprises a second sorbent material.

4. The system of claim 2, comprising a hydrocracker disposed in the hydroprocessing section downstream from the hydrotreater, wherein the hydrocracker is configured to receive the hydrotreated liquid product and to generate a hydrocracked liquid product.

5. The system of claim 4, comprising a conversion unit disposed downstream from and fluidly coupled to the pretreating system, wherein the conversion unit is configured to receive the hydrocracked liquid product and to generate ethylene, propylene, butylene, and combinations thereof from the hydrocracked liquid product.

6. The system of claim 1, comprising a conversion unit disposed downstream from and fluidly coupled to the pretreating system, wherein the conversion unit is configured to receive the treated liquid plastic-derived oil and to generate ethylene, propylene, butylene, and combinations thereof from the treated liquid plastic-derived oil.

7. The system of claim 1, comprising a preheating system disposed upstream from and fluidly coupled to the pretreating system, wherein the preheating system comprises one or more heating devices configured to heat the liquid plastic-derived oil.

8. The system of claim 1, wherein the sorbent material further comprises, a zeolite containing 12 member ring channels, a zeolite containing 10 member ring channels, a doped zeolitic molecular sieve, a non-zeolitic molecular sieve, clay, silica gel, alumina, sodium aluminate or ammonium containing materials, mixed metal oxides, metal-organic frameworks (MOF), or combinations thereof.

9. The system of claim 1, wherein the sorbent material has a surface area of between approximately 200 m²/g and approximately 800 m²/g, an alkali metal content between 1% and 40%, a Si/Al of between 1 and 5, or a combination thereof.

10. The system of claim 1, wherein the sorbent material has a mole sieve average crystallite size from between approximately 5 nanometers (nm) and 100 microns (μm).

11. The system of claim 1, wherein the one or more reactors comprises a plurality of reactors arranged in series, parallel, or both.

12. The system of claim 1, comprising a cleaning system fluidly coupled to the one or more reactors, wherein the cleaning system is configured to provide one or more cleaning fluids to the one or more reactors and to regenerate the sorbent material.

13. A process for the treatment of a liquid plastic-derived oil comprising:
feeding the liquid plastic-derived oil to a pretreating system comprising one or more reactors having a sorbent material comprising a faujasite (FAU) crystal framework type zeolitic molecular sieve, wherein the liquid plastic-derived oil is derived from solid plastic waste (SPW), comprises one or more contaminants, and has a first contamination level;
contacting, at a temperature equal to or greater than 125° C., the liquid plastic-derived oil with the sorbent material, wherein the sorbent material is configured to remove a first portion of the one or more contaminants and to generate a treated liquid plastic-derived oil having a second contamination level that is less than the first contamination level, and wherein the first portion of the one or more contaminants comprises a halogen; and
feeding the treated liquid plastic-derived oil to a conversion unit disposed downstream from and fluidly coupled to the pretreating system, wherein the conversion unit comprises one or more reactors configured to convert the treated liquid plastic-derived oil into ethylene, propylene, butylene, and combinations thereof.

14. The process of claim 13, comprising feeding the treated liquid plastic-derived oil to a hydroprocessing system disposed between the pretreating system and the conversion unit, wherein the hydroprocessing system comprises a hydroprocessing catalyst and is configured to remove a second portion of the one or more contaminants from the treated liquid plastic-derived oil before feeding the treated liquid plastic-derived oil to the conversion unit.

15. The process of claim 14, wherein the hydroprocessing system comprises a hydrotreater, a hydrocracker, or both.

16. The process of claim 15, comprising adding a second sorbent to the hydrotreater, wherein the second sorbent is a faujasite (FAU) crystal framework type zeolitic molecular sieve.

17. The process of claim 13, wherein a pressure within the pretreating system is between approximately 0 barg and approximately 17 barg.

18. The process of claim 13, wherein the sorbent material further comprises a zeolite containing 12 member ring channels, a zeolite containing 10 member ring channels, a doped zeolitic molecular sieve, a non-zeolitic molecular sieve, clay, silica gel, alumina, sodium aluminate or ammonium containing materials, mixed metal oxides, metal-organic frameworks (MOF), or combinations thereof.

19. The process of claim 13, wherein the sorbent material has a surface area of between approximately 200 m²/g and approximately 800 m²/g, an alkali metal content between 1% and 40%, a Si/Al of between 1 and 5, or a combination thereof.

20. The process of claim 13, wherein the sorbent material has a mole sieve crystallite size from between approximately 5 nanometers (nm) and 100 microns (μm).

21. The process of claim 13, comprising feeding a cleaning fluid to the one or more reactors; and regenerating the sorbent material.

22. A system for the treatment of liquid plastic-derived oil comprising:
a pretreating section comprising a pretreating system having one or more reactor trains configured to receive a liquid plastic-derived oil having one or more contaminants and a first contamination level, wherein the one or more reactor trains comprises a plurality of reactors, each reactor in the plurality of reactors having a sorbent material comprising a faujasite (FAU) crystal framework type zeolitic molecular sieve and configured to remove a first portion of the one or more contaminants from the liquid plastic-derived oil and to generate a treated liquid plastic-derived oil having a second contamination level that is less than the first contamination level, and wherein the liquid plastic-derived oil is derived from a solid plastic waste (SPW), and wherein the first portion of the one or more contaminants comprises a halogen; and
a conversion unit disposed downstream from the pretreating section, wherein the conversion unit comprises one or more reactors configured to receive the treated liquid plastic-derived oil and to convert the treated liquid plastic-derived oil into ethylene, propylene, butylene, and combinations thereof.

23. The system of claim 22, comprising a hydroprocessing system disposed between the pretreating system and the conversion unit, wherein the hydroprocessing system is configured to remove a second portion of the one or more contaminants from the liquid plastic-derived oil.

24. The system of claim 23, wherein the hydroprocessing system comprises a hydrotreater, a hydrocracker, or both, and wherein the hydrotreater is disposed upstream of the hydrocracker.

25. The system of claim 24, wherein the hydrotreater comprises a second sorbent material, and wherein the second sorbent material is a faujasite (FAU) crystal framework type zeolitic molecular sieve.

26. The system of claim 22, wherein the sorbent material further comprises a zeolite containing 12 member ring channels, a zeolite containing 10 member ring channels, a doped zeolitic molecular sieve, a non-zeolitic molecular sieve, clay, silica gel, alumina, sodium aluminate or ammonium containing materials, mixed metal oxides, metal-organic frameworks (MOF), or combinations thereof.

27. The system of claim 22, wherein the sorbent material has a mole sieve crystallite size from between approximately 5 nanometers (nm) and 100 microns (μm).

28. The system of claim 22, wherein the sorbent material has a surface area of between approximately 200 m²/g and approximately 800 m²/g, an alkali metal content between 1% and 40%, a Si/Al of between 1 and 5, or a combination thereof.

29. The system of claim 22, wherein the plurality of reactors is arranged in series, parallel, or both.

30. The system of claim 22, comprising a cleaning system fluidly coupled to the plurality of reactors, wherein the cleaning system is configured to provide one or more cleaning fluids to the plurality of reactors and to regenerate the sorbent material.
